(19) United States
(12) Patent Application Publication
(10) Pub. No.: US 2013/0026734 A1
(43) Pub. Date: Jan. 31, 2013

(54) SCOOTER WITH FOLDING DEVICE AND FOLDING DEVICE

(71) Applicants: Tingting Zhang, Shanghai (CN); Yonghao Deng, Shanghai (CN); Xiuping Wang, Shanghai (CN)

(72) Inventors: Tingting Zhang, Shanghai (CN); Yonghao Deng, Shanghai (CN); Xiuping Wang, Shanghai (CN)

(73) Assignee: SHANGHAI MAGIC WHEELS SPORTING GOODS CO., LTD., Shanghai (CN)

(21) Appl. No.: 13/565,371

(22) Filed: Aug. 2, 2012

(30) Foreign Application Priority Data
Nov. 26, 2010 (CN) 201020632228.X

(51) Int. Cl. E05D 11/10; E05D 3/02; B62M 1/00

(52) U.S. Cl. 280/287; 16/319; 16/349

(57) ABSTRACT

The invention relates to a scooter with a folding device and the folding device. The folding device comprises a first rotating part, a second rotating part and a locking part. The second rotating part is pivotally connected with the first rotating part such that the second rotating part is rotatable about a pivot axis relative to the first rotating part. The locking part comprises a locking pin which is movable in the direction of the pivot axis between a locked position and a released position. When the locking pin is in the released position, the second rotating part is rotatable relative to the first rotating part. When the locking pin is in the locked position, the second rotating part is locked and not rotatable relative to the first rotating part. This folding device has compact structure and simple appearance. The scooter is convenient to carry and store.

### FIELD OF THE INVENTION

The invention relates to a scooter for riding and for use in sport/recreation, and more particularly to a scooter with a folding device and the folding device.

### BACKGROUND

With continuous development of recreation and sport equipment, a scooter as modern recreation equipment is used by nearly every family. Both as a novel transport tool and as recreation equipment, the scooter brings people lots of convenience and fun. The scooter has gained popularity among many people, especially among youngsters.

In order to facilitate carrying and storing or placing, the scooter is usually designed to be a foldable structure so as to reduce the overall volume of the scooter and the space occupied.

Chinese Utility Model Patent Issue No. CN2432980Y discloses a C-type folding device for a scooter frame, which comprises an adjusting pipe having an upper end which is connected to a beam pipe and a lower end connected to a front fork, a square pipe welded with the adjusting pipe at a certain angle and two bracket plates provided symmetrically at both sides of the square pipe and welded with a bottom plate. The two bracket plates are sector type. Each bracket plate is provided with an arc-shaped slot centered on a connection shaft and used for switching between two states of folding. The two bracket plates are pivotally connected with the square pipe via the connection shaft, so that the square pipe together with the adjusting pipe can be folded along the direction towards the bottom plate, thereby folding of the scooter is performed. However, the folding device consisting of the adjusting pipe, the square pipe and the bracket plates has a large size and is not compact in structure. This folding scooter may reduce its overall height to a certain degree and decrease its overall volume after being folded, but because the folding device itself has a larger volume, this scooter still has a relatively large overall volume after being folded, and will still occupy a large space. In addition, because the adjusting pipe, the square pipe and the bracket plates are usually made of steel, the folding device will inevitably have a heavier weight, which in turn increases the total weight of the scooter. Accordingly, the scooter is not easy to keep and store and is inconvenient to carry.

Therefore, it is urgently needed for an improvement to scooters to overcome the above technical issues existing in the prior art.

### SUMMARY

An object of the invention is to provide a scooter with a folding device and its folding device, wherein the folding device is safe and reliable and the scooter is convenient to carry and store.

In order to achieve the above object, in one aspect, the invention provides a folding device used for a scooter, the folding device comprising a first rotating part, a second rotating part and a locking part, wherein the second rotating part is pivotally connected with the first rotating part, so that the second rotating part is rotatable about a pivot relative to the first rotating part. The locking part comprises a locking pin which is movable in the direction of the pivot between a locked position and a released position. When the locking pin is in the released position, the second rotating part is rotatable relative to the first rotating part, and when the locking pin is in the locked position, the second rotating part is locked and not rotatable relative to the first rotating part.

Preferably, the first rotating part is provided with at least two first locking holes, and the second rotating part is provided with a second locking hole. The second rotating part is rotatable about the pivot relative to the first rotating part between a first angle and a second angle, and may be locked at the first angle and second angle. When at the first angle or second angle, the second locking hole is aligned with the at least two first locking holes, and the locking pin enters the aligned second locking hole and first locking hole to stop the second rotating part from rotating relative to the first rotating part.

Preferably, the first rotating part is symmetrically provided with four first locking holes, the second rotating part is symmetrically provided with four second locking holes, and the locking part comprises four locking pins.

Preferably, the first rotating part comprises two oppositely arranged rotating pieces and the second rotating part is installed between the two rotating pieces. The locking part further comprises a locking piece and a driving mechanism. The locking piece is located at the outside of the rotating piece, and the locking pin protrudes along the axial direction of the pivot from the inside of the locking piece. The driving mechanism actuates the locking piece to move in the direction of the pivot between the locked position and the released position.

Preferably, the driving mechanism comprises a shaft part and a lever part pivotally connected with the shaft part. The shaft part positions the first rotating part and the second rotating part relatively rotatable about the pivot, and the locking piece is positioned to be movable along the pivot relative to the first rotating part. The locking piece is moved in the direction of the pivot between the locked position and the released position by operating the lever part.

Preferably, a spring compressed by axial preload is installed between the locking piece and the first rotating part. The lever part comprises opposite first end portion and second end portion. The first end portion is pivotally connected with the shaft part, and the first end portion abuts against the locking piece to exert a driving force to the locking piece counteracting the elastic force of the spring. The lever part is actuated via operating the second end portion to rotate between a first position adjacent to the locking piece and a second position away from the locking piece, so that when the lever part is rotated to the first position, the first end portion advances axial displacement of the locking piece to compress the spring and to let the locking pin enter the aligned second locking hole and first locking hole, and when the lever part is rotated to the second position, the first end portion retracts so that the locking piece is displaced axially under the elastic force of the compressed spring and the locking pin is withdrawn from the second locking hole.

Preferably, the locking part comprises two locking pieces which are respectively located at the outside of the two oppositely arranged rotating pieces.

Preferably, the rotating piece has an arc-shaped edge protruding towards the outside, and the locking piece is round-lid shaped and is located inside the arc-shaped edge.

Preferably, both the first rotating part and the second rotating part are provided with positioning holes, and the locking piece is provided with a positioning post in a position corresponding to the positioning holes, and the locking piece is provided with a fixing hole through the positioning post. The positioning post of the locking piece is positioned in the positioning holes of the first rotating part and the second rotating part, and the shaft part is positioned in the fixing hole of the locking piece, so that the first rotating part, the second rotating part and the locking piece are relatively positioned via the shaft part.

In another aspect, the invention provides a scooter with a folding device, the scooter comprising a steering column, a steerable wheel connected at a lower end of the steering column, a frame and a direction-fixed wheel connected at a rear end of the frame, and the steering column is connected with the frame via the above-mentioned folding device, wherein one of the first rotating part and the second rotating part in the folding device is fixed onto the frame, and the other is fixed to the steering column.

The folding device of the invention forms a structure that is rotatable about a pivot by pivotal connection of the first rotating part and the second rotating part, and the locking pin of the locking part is moved in the direction of the pivot, which can realize the locking and releasing of the folding device. Therefore, the folding device is easy to operate, and is safe and reliable, and itself has a small size, thus minimizing the space occupied by the total scooter after folding and facilitating placement, storage and carrying of the scooter. In addition, due to reasonable structural design, the folding device can be made by low-cost materials and technologies, and components having aesthetic appearance and good safe performance.

Other aspects and features of the invention will become apparent below with reference to the detailed description of the accompanying drawings. But it should be understood that the accompanying drawings are only designed for the purpose of explanation, rather than limiting the scope of the invention which should be referred to the appended claims. It should be also understood that, unless otherwise indicated, the accompanying drawings are not necessarily drawn to scale and they only attempt to conceptually explain the structure and flow described herein.

### BRIEF DESCRIPTION OF THE DRAWINGS

The embodiments of the invention will be described in detail below with reference to the accompanying drawings, wherein:

FIG. 1 illustrates a perspective schematic view of a scooter with a folding device according to one embodiment of the invention in an unfolded state.

FIG. 2 illustrates a partially exploded schematic view of the scooter with the folding device shown in FIG. 1.

FIG. 3 illustrates a partially exploded schematic view of the scooter with the folding device shown in FIG. 1 from another viewing angle.

FIG. 4 illustrates a partially sectional schematic view of the folding device of the scooter with the folding device shown in FIG. 1, in which a locking pin is in a locked position.

FIG. 5 illustrates a partially sectional schematic view of the folding device of the scooter with the folding device shown in FIG. 1 in another state, in which the locking pin is in a released position.

FIG. 6 illustrates a schematic view of the scooter with the folding device shown in FIG. 1 in a folded state.

### DETAILED DESCRIPTION OF THE EMBODIMENTS

In order to make the above objectives, features and advantages of the invention more apparent and easily understood, the embodiments of the invention will be described in further detail below with reference to the accompanying drawings.

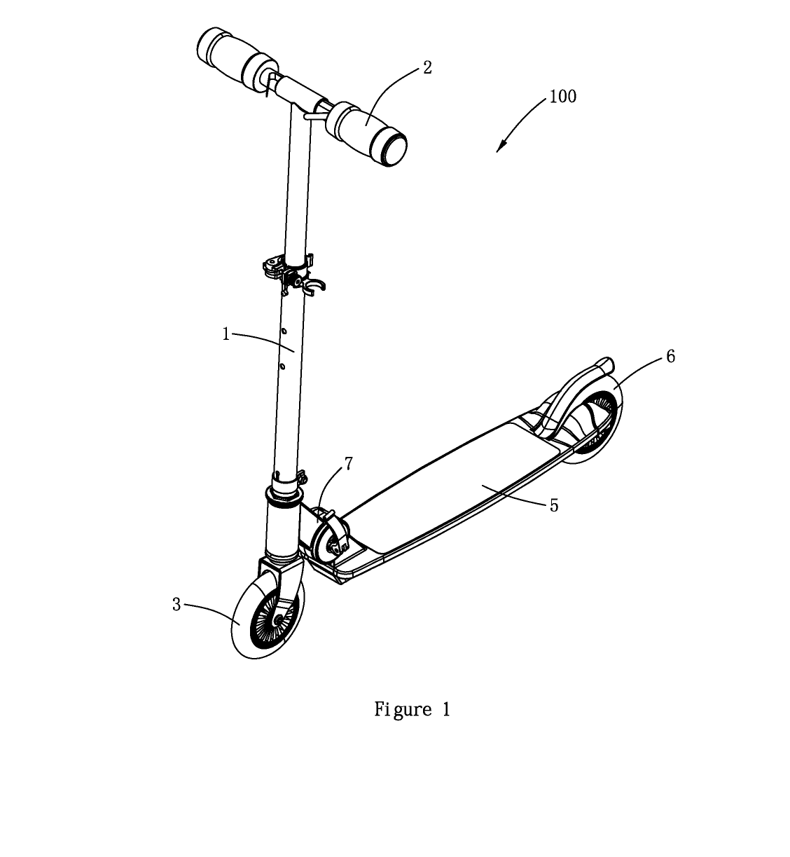

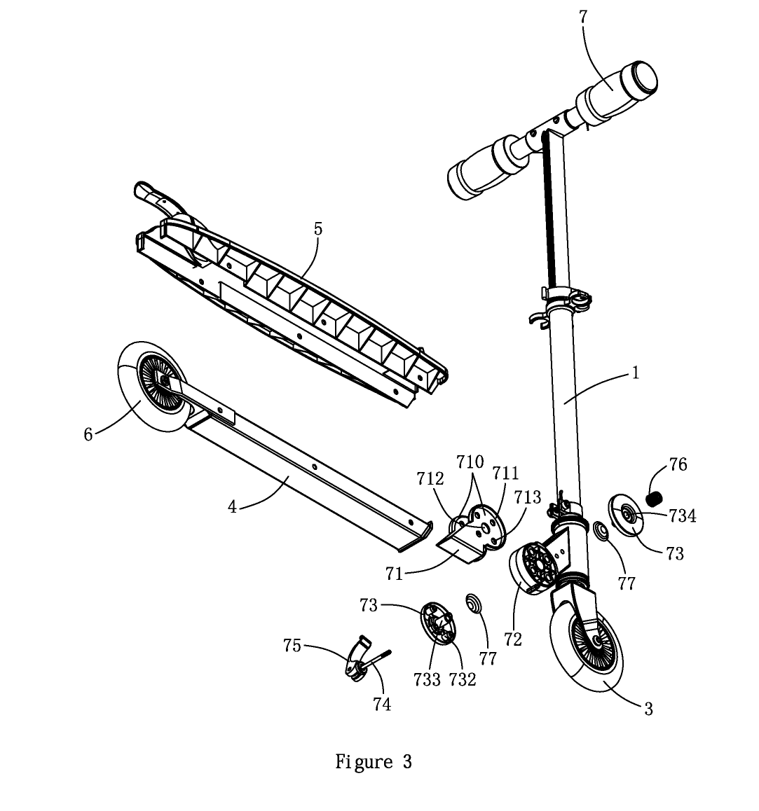

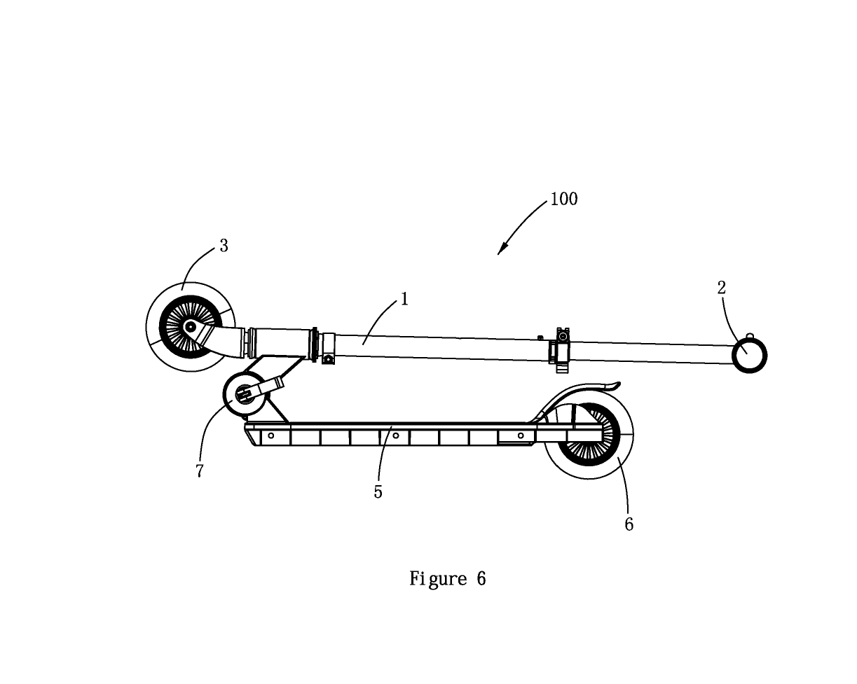

Referring to FIGS. 1-3 and FIG. 6, a scooter 100 with a folding device according to an embodiment of the invention comprises a steering column 1, a handle 2 connected at an upper end of the steering column 1, a steerable wheel 3 connected at a lower end of the steering column 1, a frame 4, a deck 5 installed on the frame 4, a direction-fixed wheel 6 connected at a rear end of the frame 4 and a folding device 7. The steering column 1 is connected with the frame 4 via the folding device 7. Folding of the scooter 100 can be realized by the folding device 7, as shown in FIG. 6, so that the scooter 100 is in a folded state when not in use, thus reducing the overall volume of the scooter 100.

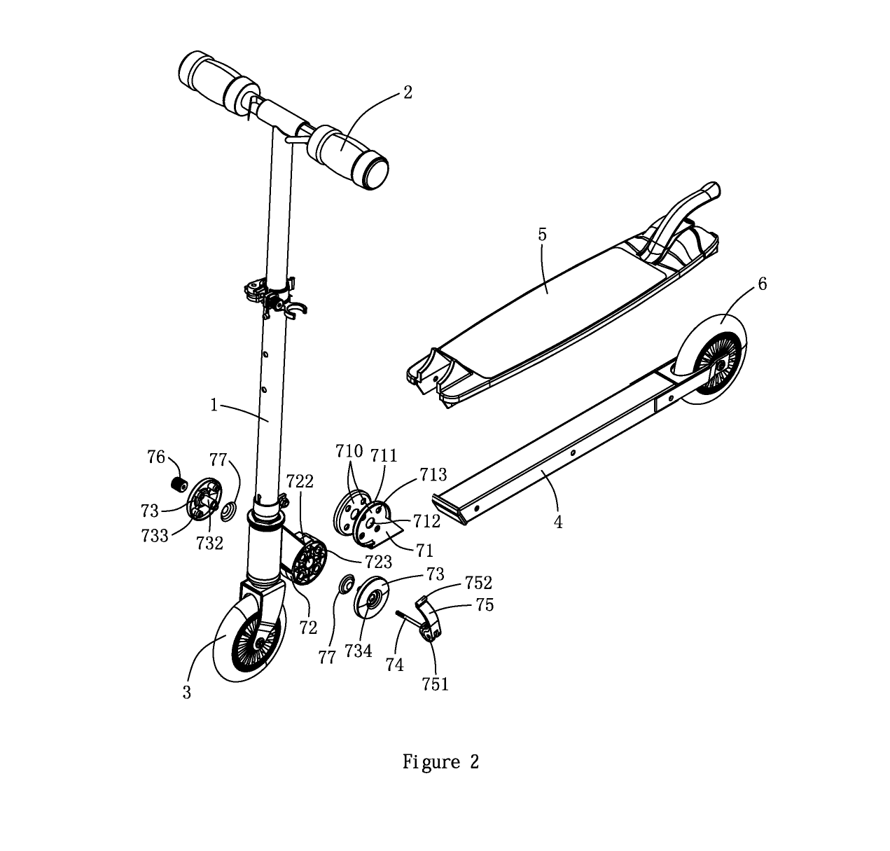

Especially referring to FIGS. 2-5, the folding device 7 comprises a first rotating part 71 fixed onto the frame 4, a second rotating part 72 fixed onto the steering column 1 and a locking part (not labeled). The first rotating part 71 is pivotally connected with the second rotating part 72, so as to enable the second rotating part 72 to rotate about a pivot 740 relative to the first rotating part 71. Certainly, according to other embodiments of the invention, the first rotating part 71 may also be fixed onto the steering column 1, and correspondingly, the second rotating part 72 is fixed onto the frame 4, which can also achieve the objects of the invention without departing from the spirit of the solutions of the invention.

In this application, unless otherwise indicated, “axial direction” and “axial direction of the pivot” both indicate the direction along the pivot axis of the folding device or the direction parallel to the pivot axis.

The first rotating part 71 comprises two spaced rotating pieces 710 provided oppositely in an interval, and each rotating piece 710 has an arc-shaped edge 711 protruding towards the outside. Each rotating piece 710 of the first rotating part 71 is provided with a first positioning hole 712, and the periphery of the first positioning hole 712 is symmetrically provided with four first locking holes 713. The second rotating part 72 is installed between the two rotating pieces 710. The second rotating part 72 is provided with a second positioning hole 722 corresponding to the first positioning hole 712, and the periphery of the second positioning hole 722 is symmetrically provided with four second locking holes 723. The second rotating part 72 is rotatable about the pivot 740 relative to the first rotating part 71 between a first angle and a second angle, and may be locked between the first angle and the second angle. The first angle and the second angle respectively correspond to an unfolded state and a folded state of the scooter 100.

The locking part comprises a driving mechanism (not labeled) and a locking piece 73 located at the outside of the rotating piece 710. According to a preferred embodiment of the invention, the locking part comprises two locking pieces 73 located at the outside of the two rotating pieces 710 provided oppositely in an interval. The driving mechanism comprises a shaft part 74 and a lever part 75 pivotally connected with the shaft part 74. The shaft part 74 defines the position of the pivot 740. The locking piece 73 is actuated to move in the axial direction of the pivot 740 between a locked position and a released position by operating the lever part 75.

The locking piece 73 is a round-lid shape, and each locking piece 73 is located inside the arc-shaped edge 711 of each rotating piece 710. A positioning post 732 and four locking pins 733 are protruded along the axial direction of the pivot 740 from the inside of each locking piece 73, the position of the positioning post 732 corresponds to the first positioning hole 712 of the first rotating part 71 and the second positioning hole 722 of the second rotating part 72, and the four locking pins 733 are respectively and symmetrically provided on the periphery of the positioning post 732. The locking piece 73 is provided with a fixing hole 734 through the positioning post 732. The positioning post 732 of the locking piece 73 is positioned in the first positioning hole 712 of the first rotating part 71 and the second positioning hole 722 of the second rotating part 72. The shaft part 74 is positioned in the fixing hole 734 of the locking piece 73, and a screw nut 76 is screwed to an end portion of the shaft part 74, so that the first rotating part 71, the second rotating part 72 and the locking piece 73 are relatively positioned, in which the shaft part 74 positions the first rotating part 71 and the second rotating part 72 relatively rotatable about the pivot 740, and the locking piece 73 is positioned to be movable along the pivot 740 relative to the first rotating part 71.

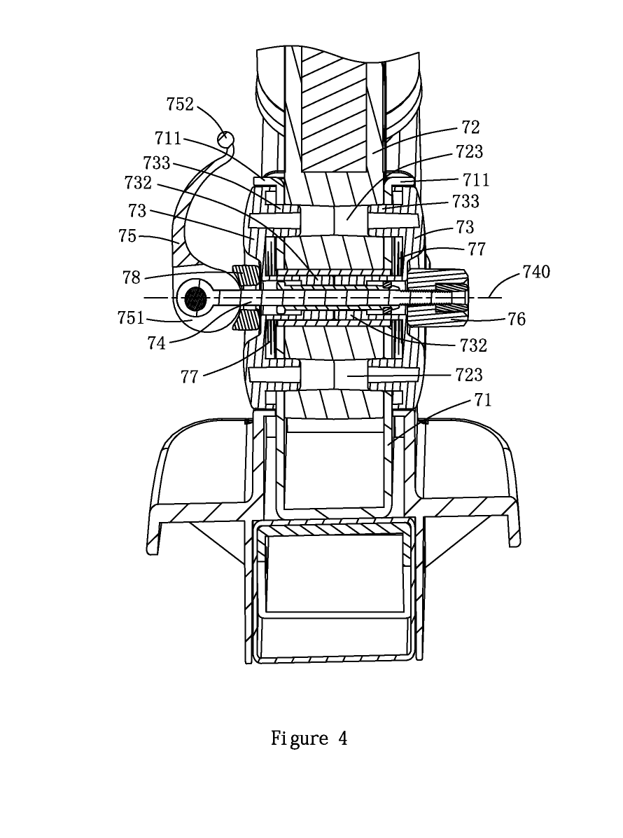

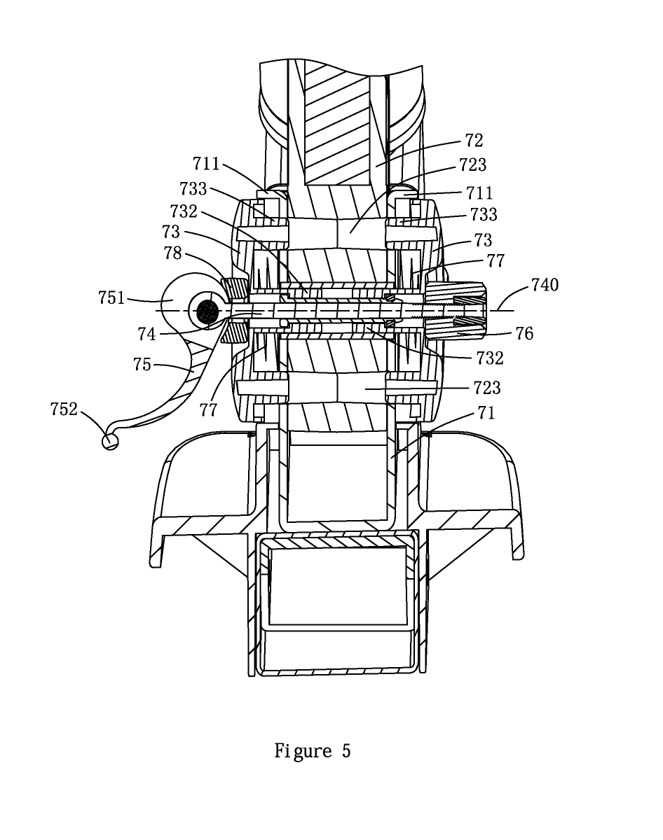

A spring 77 compressed by axial preload is installed between the locking piece 73 and the rotating piece 710 of the first rotating part 71. Under actuation of the driving mechanism, the locking piece 73 and the locking pin 733 on the locking piece 73 can be moved in the direction of the pivot 740 between the locked position and the released position. When the locking pin 733 is in the released position, as shown in FIG. 5, the second rotating part 72 is rotatable relative to the first rotating part 71, and in turn the steering column 1 is rotatable in the folding direction relative to the deck 5. When the locking pin 733 is in the locked position, as shown in FIG. 4, the second rotating part 72 is locked and not rotatable relative to the first rotating part 71, and in turn the steering column 1 is not rotatable in the folding direction relative to the deck 5.

When the locking pin 733 enters the locked position, there are two situations which comprise the second rotating part 72 is at the first angle and at the second angle relative to the first rotating part 71. When the second rotating part 72 is at the first angle relative to the first rotating part 71, for example as shown in FIG. 1, the steering column 1 is in an approximately vertical position relative to the horizontal deck 5, and the scooter 100 is in an unfolded state. At this time, the second locking hole 723 on the second rotating part 72 is aligned with the first locking hole 713 on the first rotating part 71, and under actuation of the driving mechanism, the locking pin 733 enters the aligned second locking hole 723 and first locking hole 713 to stop the second rotating part 72 from rotating relative to the first rotating part 71, so that the steering column 1 is not rotatable in the folding direction relative to the deck 5, and the scooter 100 is kept in the unfolded state in order to facilitate the user's riding. When the second rotating part 72 is at the second angle relative to the first rotating part 71, for example as shown in FIG. 6, the steering column 1 is in an approximately horizontal position relative to the horizontal deck 5, and the scooter 100 is in a folded state. At this time, the second locking hole 723 on the second rotating part 72 is again aligned with the first locking hole 713 on the first rotating part 71, and under actuation of the driving mechanism, the locking pin 733 again enters the aligned second locking hole 723 and first locking hole 713 to stop the second rotating part 72 from rotating relative to the first rotating part 71, so that the steering column 1 is not rotatable in the folding direction relative to the deck 5, and the scooter 100 is kept in the folded state in order to facilitate storage and carrying. When the locking pin 733 is in the released position, rotation of the second rotating part 72 relative to the first rotating part 71 between the first angle and the second angle is realized.

The folding device 7 of the invention is symmetrically provided with four first locking holes 713 on the rotating piece 710 of the first rotating part 71 and symmetrically provided with four second locking holes 723 on the second rotating part 72, and is provided with four locking pins 733 matching with the first locking holes 713 and the second locking holes 723. When locked, the four locking pins 733 work at the same time, so that the scooter 100 is reliably locked in the unfolded state and the folded state, and however, the invention is not limited hereto. Actually, it can be realized that the scooter 100 is in the unfolded and the folded states as long as the first rotating part 71 is provided with at least two first locking holes 713 and the second rotating part 72 is provided with at least one second locking hole 723. For example, the first rotating part 71 is provided with two first locking holes 713, and the second rotating part 72 is provided with one second locking hole 723. When the second locking hole 723 on the second rotating part 72 is aligned with one of the first locking holes 713 on the first rotating part 71, the locking pin 733 enters the aligned second locking hole 723 and the first locking hole 713 to stop the second rotating part 72 from rotating relative to the first rotating part 71, and at this time, the scooter may be in the unfolded state. When the second locking hole 723 on the second rotating part 72 and the other first locking hole 713 on the first rotating part 71 are aligned, the locking pin 733 again enters the aligned second locking hole 723 and first locking hole 713 to stop the second rotating part 72 from rotating relative to the first rotating part 71, and at this time, the scooter 100 may be in the folded state. Therefore, the unfolded and folded states of the scooter 100 can also be realized.

The lever part 75 comprises opposite first end portion 751 and second end portion 752. The first end portion 751 is pivotally connected with the shaft part 74, and the first end portion 751 abuts against the locking piece 73 to exert a driving force to the locking piece 73 counteracting the elastic force of the spring 77. When the lever part 75 rotates relative to the shaft part 74, the lever part 75 is enabled via operating the second end portion 752 to rotate between a first position adjacent to the locking piece 73 and a second position away from the locking piece 73, so that when the lever part 75 is rotated to the first position, the first end portion 751 advances axial displacement of the locking piece 73 to compress the spring 77 and to let the locking pin 733 enter the aligned second locking hole 723 and first locking hole 713. At this time, the locking piece 73 is in the locked position, and the second rotating part 72 is not rotatable relative to the first rotating part 71, and therefore the steering column 1 is not rotatable relative to the deck 5. When the lever part 75 is rotated to the second position, the first end portion 751 retracts so that the locking piece 73 is displaced axially under the elastic force of the compressed spring 77 and the locking pin 733 is withdrawn from the aligned second locking hole 723. At this time, the locking piece 73 is in the released position, and the second rotating part 72 is rotatable relative to the first rotating part 71, and therefore the steering column 1 is rotatable relative to the deck 5. The locking piece 73 can be moved from the locked position to the released position by using an external force to operate the second end portion 752 of the lever part 75, so that it can be realized that the scooter 100 is locked in the predetermined unfolded state or folded state. Preferably, a pad 78 is installed between the lever part 75 and the locking piece 73.

According to the invention, the folding device 7 of the scooter 100 provided between the steering column 1 and the frame 4 has good and simple appearance, compact structure design and a smaller size, and occupies a smaller space. The scooter 100 is convenient to store and carry. Moreover, the scooter 100 is simple and convenient in folding operation, and is safe and reliable in use. In addition, due to reasonable structural design, the first rotating part 71 and the second rotating part 72 are substantially located inside without affecting the appearance. There is no need for aesthetic appearance treatment, which allows selecting low-cost manufacturing technologies and materials. The locking piece 73 can be made of plastic materials to reduce the manufacturing cost, which facilitates manufacture of safe and aesthetic components.

The invention is disclosed above in the preferred embodiments which are not intended to limit the invention, and possible alternations and modifications can be made by one skilled in the art without departing from the spirit and scope of the invention, so the protection scope of the invention should be referred to the appended claims.

What is claimed is:

1. A folding device used for a scooter, comprising:
a first rotating part;
a second rotating part pivotally connected to the first rotating part such that the second rotating part is rotatable about a pivot axis relative to the first rotating part; and
a locking part comprising a locking pin movable in the direction of the pivot axis between a locked position and a released position,
wherein the second rotating part is rotatable relative to the first rotating part when the locking pin is in the released position, and the second rotating part is locked and not rotatable relative to the first rotating part when the locking pin is in the locked position.

2. The folding device used for a scooter according to claim 1, wherein the first rotating part has at least two first locking holes, and the second rotating part has a second locking hole, and second rotating part is rotatable about the pivot axis relative to the first rotating part between a first angle and a second angle, and may be locked at the first angle and second angle, and wherein at the first angle or the second angle the second locking hole is aligned with the first locking hole and the locking pin enters the aligned second locking hole and first locking hole to stop the second rotating part from rotating relative to the first rotating part.

3. The folding device used for a scooter according to claim 2, wherein the first rotating part is symmetrically provided with four first locking holes, and the second rotating part is symmetrically provided with four second locking holes, and the locking part comprises four locking pins.

4. The folding device used for a scooter according to claim 1, wherein the first rotating part comprises two spaced oppositely arranged rotating pieces, and wherein the second rotating part is installed between the two rotating pieces, the locking part further comprising
a locking piece located adjacent an outer surface of the rotating piece, the locking pin protruding along the direction of the pivot axis from the inside of the locking piece; and
a driving mechanism for actuating the locking piece to move in the direction of the pivot axis between the locked position and the released position.

5. The folding device used for a scooter according to claim 4, wherein the driving mechanism comprises a shaft part, and a lever part pivotally connected to the shaft part, wherein the shaft part positions the first rotating part and the second rotating part relatively rotatable about the pivot axis, and wherein the locking piece is positioned to be movable along the pivot axis relative to the first rotating part between the locked position and the released position by operating the lever part.

6. The folding device used for a scooter according to claim 5, further comprising a spring compressed by axial preload installed between the locking piece and the first rotating part, the lever part comprising a first end portion and an opposite second end portion, the first end portion pivotally connected with the shaft part and abutting against the locking piece to exert a driving force to the locking piece counteracting the elastic force of the spring, wherein the lever part is enabled via operating the second end portion to rotate between a first position adjacent to the locking piece and a second position away from the locking piece such that when the lever part is rotated to the first position the first end portion advances axial displacement of the locking piece to compress the spring and cause the locking pin to enter the aligned second locking hole and first locking hole, and when the lever part is rotated to the second position the first end portion retracts so that the locking piece is displaced axially under the elastic force of the compressed spring and the locking pin is withdrawn from the second locking hole.

7. The folding device used for a scooter according to claim 4, wherein the locking part comprises two locking pieces which are respectively located adjacent the respective outer surfaces of the two oppositely arranged spaced rotating pieces.

8. The folding device used for a scooter according to claim 7, wherein the rotating piece has an arc-shaped outer edge, and the locking piece is round-lid shaped and is located inside the arc-shaped edge.

9. The folding device used for a scooter according to claim 5, wherein both the first rotating part and the second rotating part are provided with positioning holes, and the locking piece further comprises a positioning post in a position corresponding to the positioning holes, the positioning post defining a fixing hole through the positioning post, wherein the positioning post of the locking piece is positioned in the positioning holes of the first rotating part and the second rotating part, and the shaft part is positioned in the fixing hole of the positioning post of the locking piece such that the first rotating part, the second rotating part and the locking piece are relatively positioned via the shaft part.

10. A scooter with a folding device, the scooter comprising:
a steering column;
a steerable wheel connected at a lower end of the steering column;
a frame;
a direction-fixed wheel connected at a rear end of the frame; and
a folding device comprising
a first rotating part;
a second rotating part pivotally connected to the first rotating part such that the second rotating part is rotatable about a pivot axis relative to the first rotating part; and
a locking part comprising a locking pin movable in the direction of the pivot axis between a locked position and a released position,
wherein the second rotating part is rotatable relative to the first rotating part when the locking pin is in the released position, and the second rotating part is locked and not rotatable relative to the first rotating part when the locking pin is in the locked position,
wherein one of the first rotating part and the second rotating part of the folding device is fixed to the frame and the other is fixed to the steering column such that the steering column is connected with the frame via the folding device.
